(19) United States
(12) Patent Application Publication
(10) Pub. No.: US 2017/0262133 A1
(43) Pub. Date: Sep. 14, 2017

(54) VIRTUAL INPUT DEVICE FOR MOBILE PHONE

(71) Applicant: SERAFIM TECHNOLOGIES INC., New Taipei City (TW)

(72) Inventors: Guo-Zen CHEN, New Taipei City (TW); Tzu-Chin WENG, New Taipei City (TW); Chih Hao CHANG, New Taipei City (TW); Shun Cheng LIN, New Taipei City (TW)

(21) Appl. No.: 15/450,913

(22) Filed: Mar. 6, 2017

(30) Foreign Application Priority Data
Mar. 8, 2016 (CN) 201620175021.1

(51) Int. Cl. G06F 3/042; G06F 1/16; A63F 13/332; A63F 13/213; A63F 13/24

(52) U.S. Cl. CPC G06F 3/0421; A63F 13/213; A63F 13/24; A63F 13/332; G06F 1/1637; A63F 2300/1075; A63F 2300/1087; A63F 2300/204

(57) ABSTRACT

A virtual input device for a mobile phone is revealed. The virtual input device includes a housing for stable placement on a flat surface, a mobile-phone mounting member that allows the mobile phone used able to be mounted thereon horizontally or vertically, and a virtual input module wirelessly connected to the mobile phone for generating a virtual input image having virtual input function and a larger area than the screen of the mobile phone. Thereby users can complete input to the mobile phone or control mobile games by the virtual input image.

### BACKGROUND OF THE INVENTION

The present invention relates to a virtual input device, especially to a virtual input device for a mobile phone that includes a housing used for stable placement on a flat surface and easy carrying. The housing is arranged with a mobile-phone mounting member that allows the mobile phone used able to be mounted thereon horizontally or vertically. A virtual input module mounted in the housing can be connected to the mobile phone wirelessly and generating a virtual input image on a on a flat surface in front of the virtual input device. Thereby users can input their data/commands or play mobile games by the virtual input image.

Nowadays mobile phones have becomes a daily essential to everyone. The telecommunication standard of the mobile phone has been developed to the current fourth generation and the proposed next fifth generation. Besides communication, the mobile phone has been used for other purposes such as personal digital assistant (PDA), game console, MP3 player, camera, recording, global positioning system (GPS), internet connection/access, etc. For example, 3.5G mobile phone not only focuses on mobile phone safety and data communication but also provides a rich multimedia experience. Now the mobile phone performs many personal computer functions. The 4G mobile phone network enables surfing on internet so that the 4G mobile phone is considered as a smartphone that provides network service along with extension of base stations Thereby users use the mobile phone for a longer time.

Generally, the mobile phone includes a liquid crystal display (screen) and a set of keys while a touch screen mobile phone reduces the buttons. Yet the touch screen has a limited area, usually smaller than that of the tablet computer or personal computer. The user holds the mobile phone with one hand and the other hand is used to operate the touch screen while using the touch screen mobile phone. The viewing angle is narrow owing to the smaller area of the touch screen and one hand is always occupied. Thus users are tired or not well after a long-term use of the mobile phone such as watching movies or playing mobile games (such as Temple Run, etc).

Like a book cover, a protective cover for tablet computers such as iPad developed by Apple Inc., is available on the market now. The protective cover includes two plates connected to each other. The iPad is mounted in and covered by the protective case while not in use. While in use, the protective cover is opened and one plate with a plurality of slots on an inner surface thereof is set on the table surface. Then the user moves the other plate attached with the iPad an angle to be locked into one of the slots of the plate on the table surface for creating a stand for the iPad. Thus the iPad is inclined at an angle on the table surface in front of the user. Therefore the user can operate or watch the touch screen of the iPad with a better viewing angle and a more comfortable posture.

The weight of the mobile phone is lighter than that of the tablet computer so that the mobile phone is easier to carry and hold. The mobile phone is a thin rectangle with a touch screen smaller than the iPad. The mobile phone cover with similar design of the above iPad protective cover allows the mobile phone to be set on the table surface while in use instead of holding with one hand. Yet the height of the mobile phone on the stable surface is limited so that the user's viewing angle is poor. The smaller touch screen is also inconvenient for viewing or touch control. Even the mobile phone can be set on the stable surface while in use, the user still has trouble in viewing and operating the mobile phone screen, especially a long-term use. For example, the user is easy to fell tired or uncomfortable after watching movies or playing Temple Run (mobile game) for a long period of tie.

In the field of the virtual input device (such as virtual keyboard) formed by projection techniques, there are quite a lot techniques available now such as a system and a method thereof that input data by using a virtual input device (virtual keyboard or virtual mouse) disclosed in U.S. Pat. No. 6,614,422, US2012/0162077, US2014/0055364, etc. However, the above techniques have the shortcomings of complicated system architecture and difficulty in microminiaturization in practice. These have negative effects on the applications of various virtual input devices. There is no microminiaturized virtual input device that is easy carrying and is used together with the mobile phone efficiently available now.

### SUMMARY OF THE INVENTION

Therefore it is a primary object of the present invention to provide a virtual input device for a mobile phone and features of stable placement on a flat surface as well as easy carrying. Moreover, the virtual input device provides mobile phone users a better and more comfortable operation mode for improving inconvenience and discomfort caused by long-term operation or watch of the mobile phone screen.

In order to achieve the above object, a virtual input device for a mobile phone according to the present invention includes a housing with a certain volume so that the virtual input device is able to be set on the surface stably and users can carry the virtual input device with them. A mobile-phone mounting member disposed on the housing allows the mobile phone used able to be mounted thereon horizontally/or vertically and a screen of the mobile phone to be inclined at an angle. Thus users can touch or watch the screen of the mobile phone with the better viewing angle and greater comfort. A virtual input module is mounted in the housing and is connected to the mobile phone wirelessly for generating a virtual input image on a flat surface between the front side of the housing and the user. The virtual input image provides virtual input function and having area larger than the screen of the mobile phone. Thereby users can perform input into the mobile phone or play mobile games by the virtual input image with a better and more comfortable operation mode.

The mobile phone is mounted on the mobile-phone mounting member horizontally or vertically. At the same time, the screen of the mobile phone is inclined at a certain angle.

The mobile-phone mounting member consists of a pivotable flip-up cover covered a top surface of the housing and a pivotable support disposed and mounted under the pivotable flip-up cover. The pivotable flip-up cover is lifted up pivotally and stopped vertically or slantingly to support a rear surface of the mobile phone while in use. After the pivotable flip-up cover being lifted up, the pivotable support is pivoted and then stopped vertically to support a front edge of the mobile phone. Thereby the mobile phone can be mounted on the mobile-phone mounting member stably and inclined at an angle.

A pivotable horseshoe-shaped bracket is arranged at an outer surface of a lower part of the housing, close to the bottom surface of the housing. The pivotable horseshoe-shaped bracket is pulled backward and pivotally rotated to be stopped horizontally at a rear side of the housing for supporting the housing while in use.

The virtual input image includes a virtual keyboard image, a virtual controller image applied to mobile games, and a virtual touch screen image,

The virtual input module includes an infrared (IR) laser light, at least two linear line sensors, a projector and a controller. The IR laser light is mounted in an opening on a lower part of a front surface of the housing and used for projecting an IR laser horizontally to form a 2-dimensional light area over, parallel and closed to the flat surface. The two linear line sensors with a preset distance therebetween are arranged in the opening of the housing and used for sensing reflected light of the IR laser caused by a control member of a user entering into the 2-dimensional light area. Thus a linear position signal is generated by each linear line sensor. The projector is set in an opening on an upper part of a front surface of the housing and used for projecting a virtual input image into the 2-dimensional light area. The controller is used for receiving and processing the linear position signals from the two linear line sensors to get the position of the control member within a 2-dimensional coordinate system of the virtual input image. Then the controller is connected to the mobile phone wirelessly for input to the mobile phone or control of the mobile games.

The two linear line sensors parallel to each other are set on the left side and the right side of the IR laser light respectively

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment not in use according to the present invention;

FIG. 2 is a front view of the embodiment in FIG. 1 in use according to the present invention;

FIG. 3 is a rear view of the embodiment in FIG. 1 in use according to the present invention;

FIG. 4 is a perspective view of the embodiment in FIG. 2 for a mobile phone that is placed horizontally according to the present invention;

FIG. 5 is another perspective view of the embodiment in FIG. 4 for a mobile phone that is mounted vertically according to the present invention;

FIG. 6 is a schematic drawing showing a top view of an embodiment in use according to the present invention;

FIG. 7 is a schematic drawing showing a side view of an embodiment in FIG. 6 according to the present invention;

FIG. 8 is a schematic drawing showing an embodiment used as a virtual keyboard for input according to the present invention;

FIG. 9 is a schematic drawing showing an embodiment used as a numeric keypad for input according to the present invention;

FIG. 10 is a schematic drawing showing an embodiment used as a virtual mouse for input according to the present invention;

FIG. 11 is a schematic drawing showing a side view of an embodiment for a mobile phone according to the present invention.

### DETAILED DESCRIPTION OF THE PREFERRED EMBODIMENTS

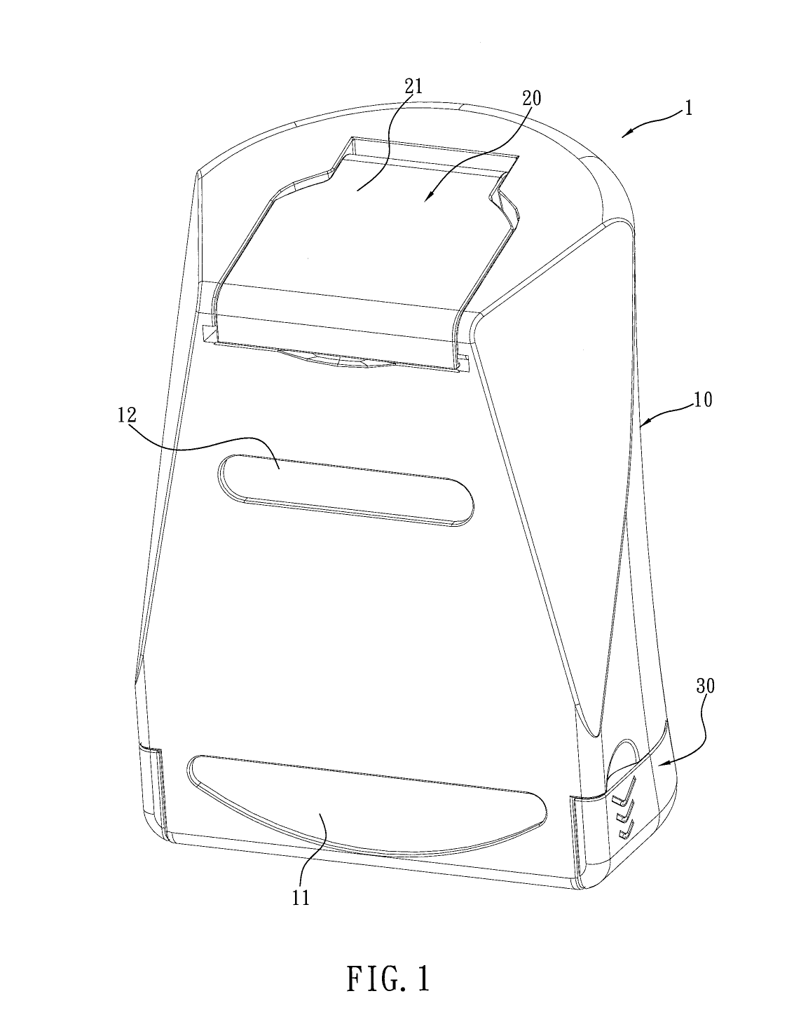

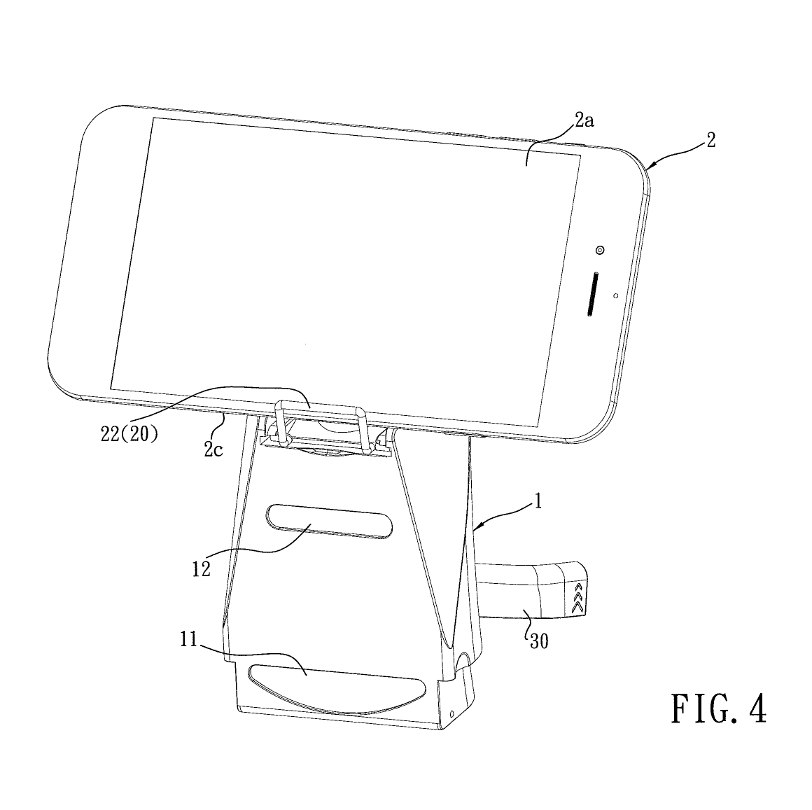

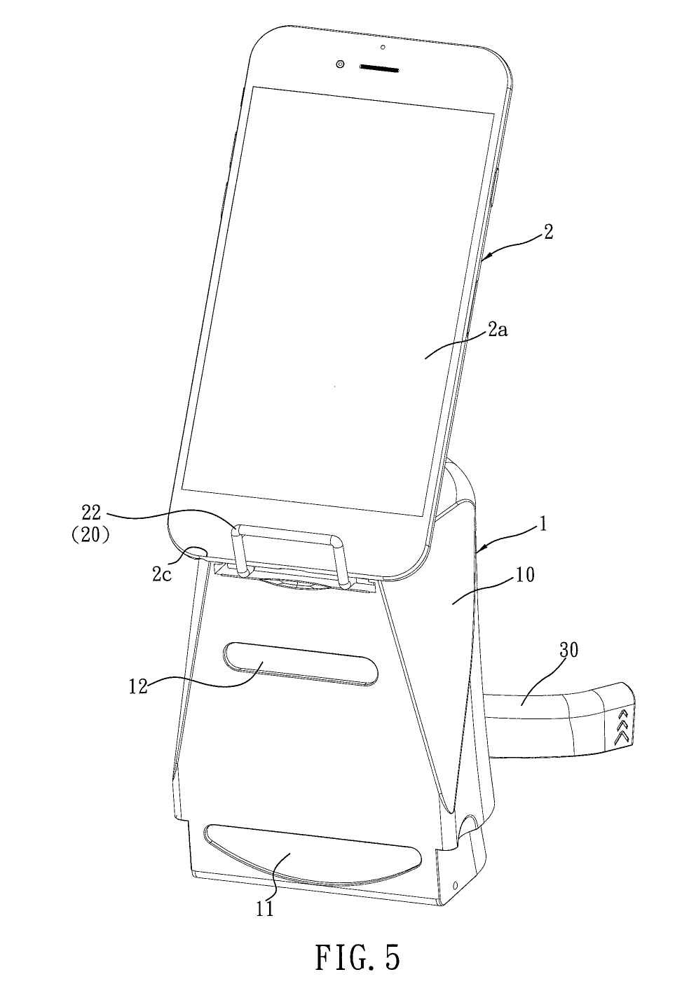

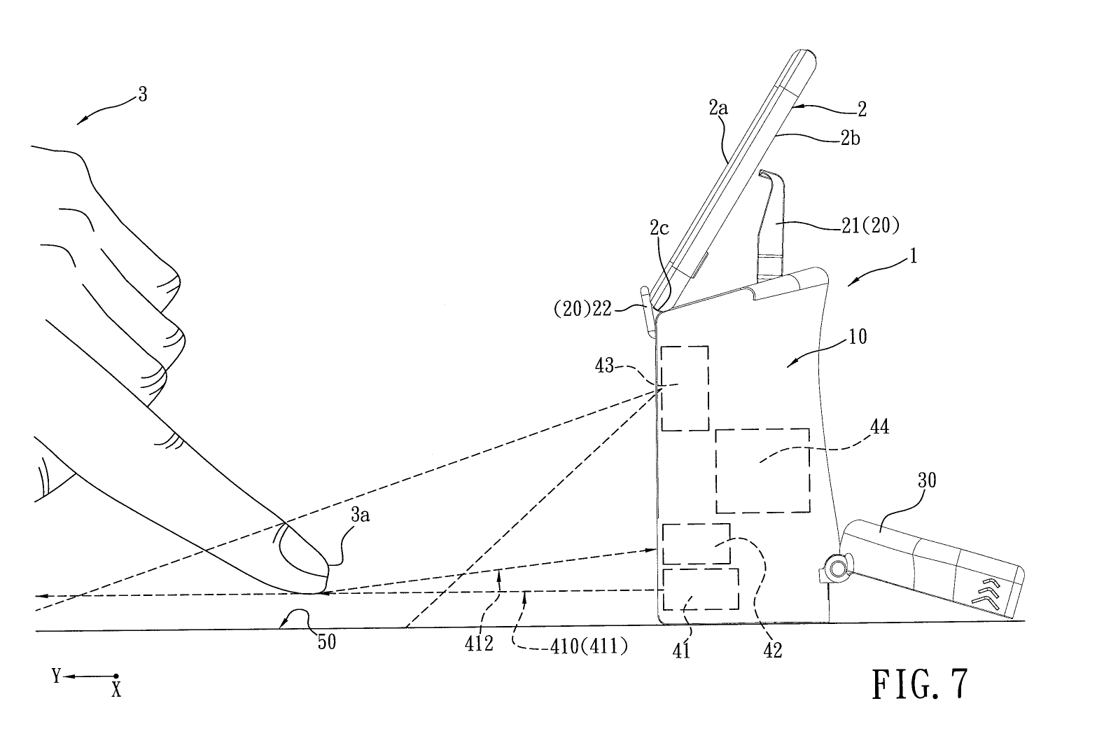

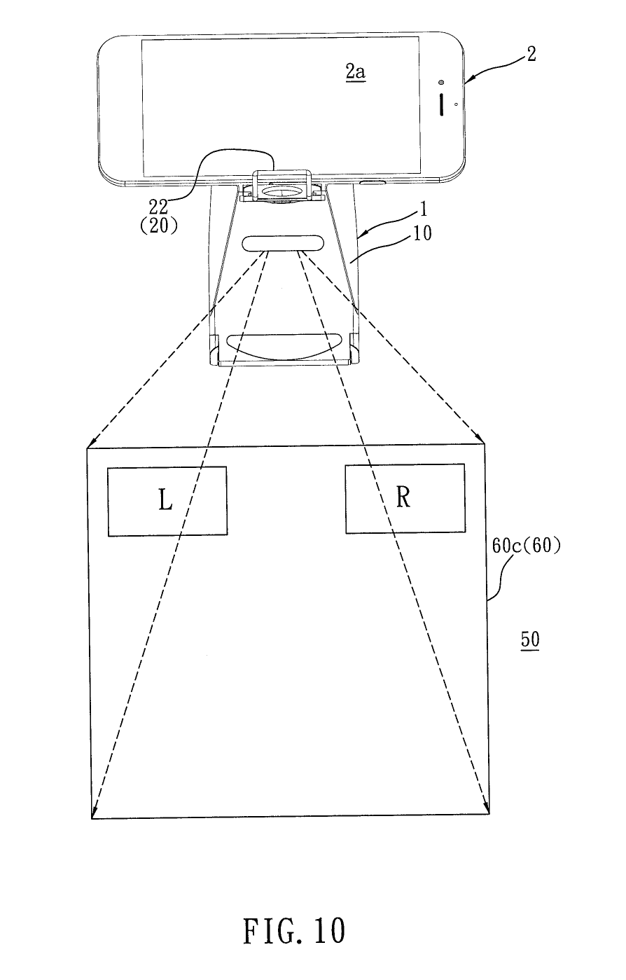

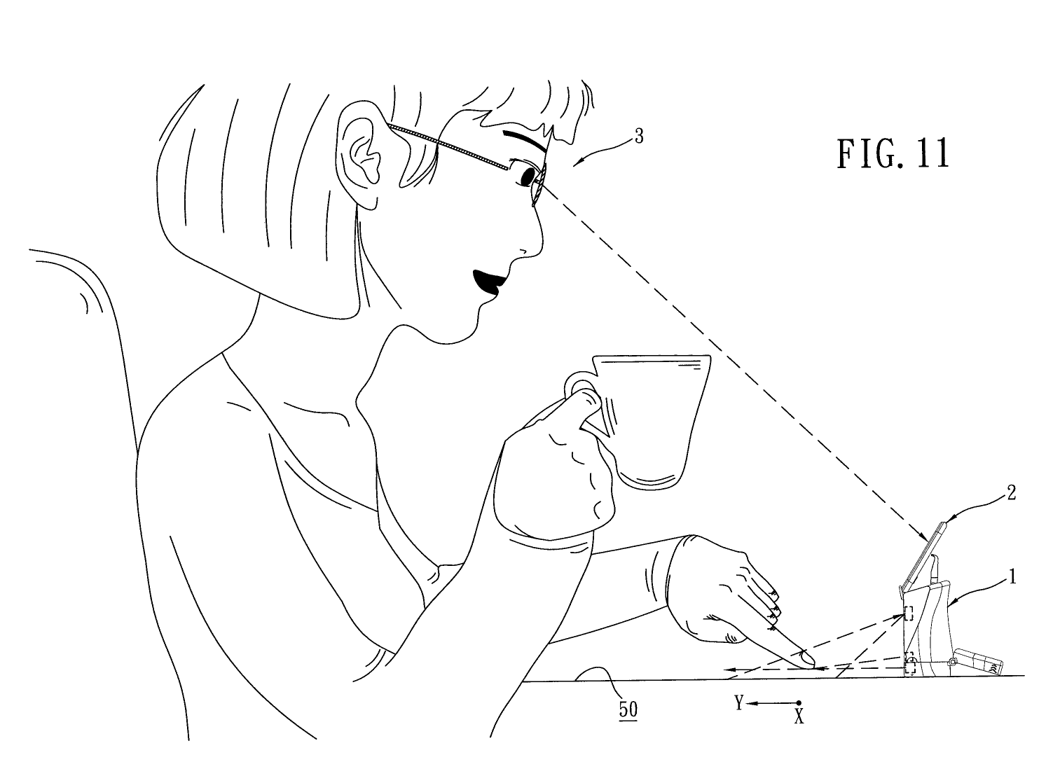

Refer from FIG. 1 to FIG. 5 and FIG. 10, a virtual input device 1 for a mobile phone 2 according to the present invention includes a housing 10, a mobile-phone mounting member 20, a pivotable horseshoe-shaped bracket 30 and a virtual input module 40. The housing 10 with a certain volume has the height of 5 cm-9 cm, the width (from left to right) of 3 cm-6 cm and the length (from front to back) of 1.5 cm-5 cm. Thus a user 3 of the mobile phone 2 can carry the virtual input device 1 for the mobile phone 2 with him/her, as shown in FIG. 7 and FIG. 10. The virtual input device 1 for the mobile phone 2 can also be placed on a flat surface stably while in use, as shown in FIG. 10. The mobile-phone mounting member 20 allows the user 3 to set the rectangular mobile phone 2 horizontally or vertically thereon, as shown in FIG. 4 and FIG. 5 respectively. A screen 2a of the mobile phone 2 is inclined at a certain angle (as shown in FIG. 4, FIG. 5, FIG. 7 and FIG. 11) owing to the mobile-phone mounting member 20. Thereby the user 3 can operate the screen 2a by touch or watch the screen 2a of the mobile phone 2 with optimal viewing angle and more comfortable posture, as shown in FIG. 11.

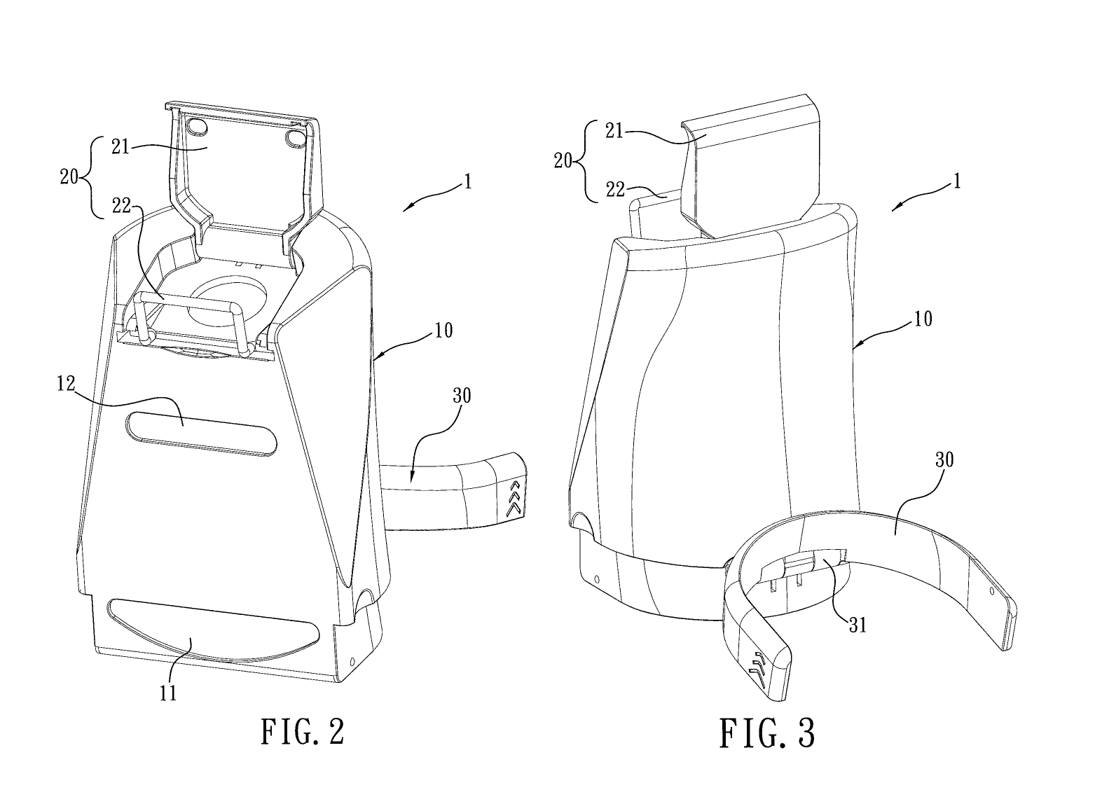

Refer to FIG. 2 and FIG. 3, the mobile-phone mounting member 20 consists of a pivotable flip-up cover 21 and a pivotable support 22. The pivotable flip-up cover 21 is arranged at and covered a top surface of the housing 10. While in use, the pivotable flip-up cover 21 is lifted up pivotally and stopped vertically or slantingly to support a rear surface 2b of the mobile phone 2. The pivotable support 22 is disposed and mounted under the pivotable flip-up cover 21. After the pivotable flip-up cover 21 being lifted up pivotally, the pivotable support 22 is pivotally rotated and stopped vertically or inclined at an angle to support a front edge 2c of the mobile phone 2. Thereby the mobile phone 2 can be set on the mobile-phone mounting member 20 stably and inclined at an angle, as shown in FIG. 4, FIG. 5, FIG. 7 and FIG. 11.

Refer to FIG. 3, the pivotable horseshoe-shaped bracket 30 is set on a surface of a lower part of the housing 10, close to the bottom surface of the housing 10. The pivotable horseshoe-shaped bracket 30 is pulled backward and pivotally rotated around a shaft 31 thereof to be stopped horizontally at a rear side of the housing 10 for supporting the housing 10 while in use. Thereby the housing 10 with the mobile phone 2 loaded on the mobile-phone mounting member 20 is set on a flat surface more stably.

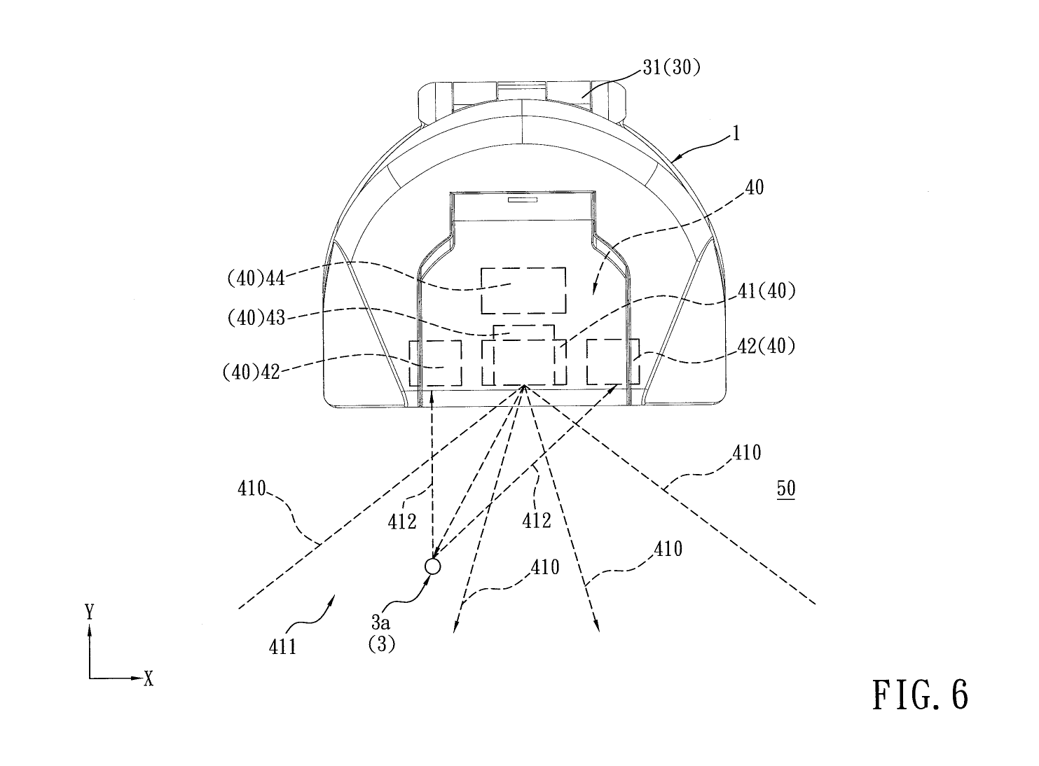

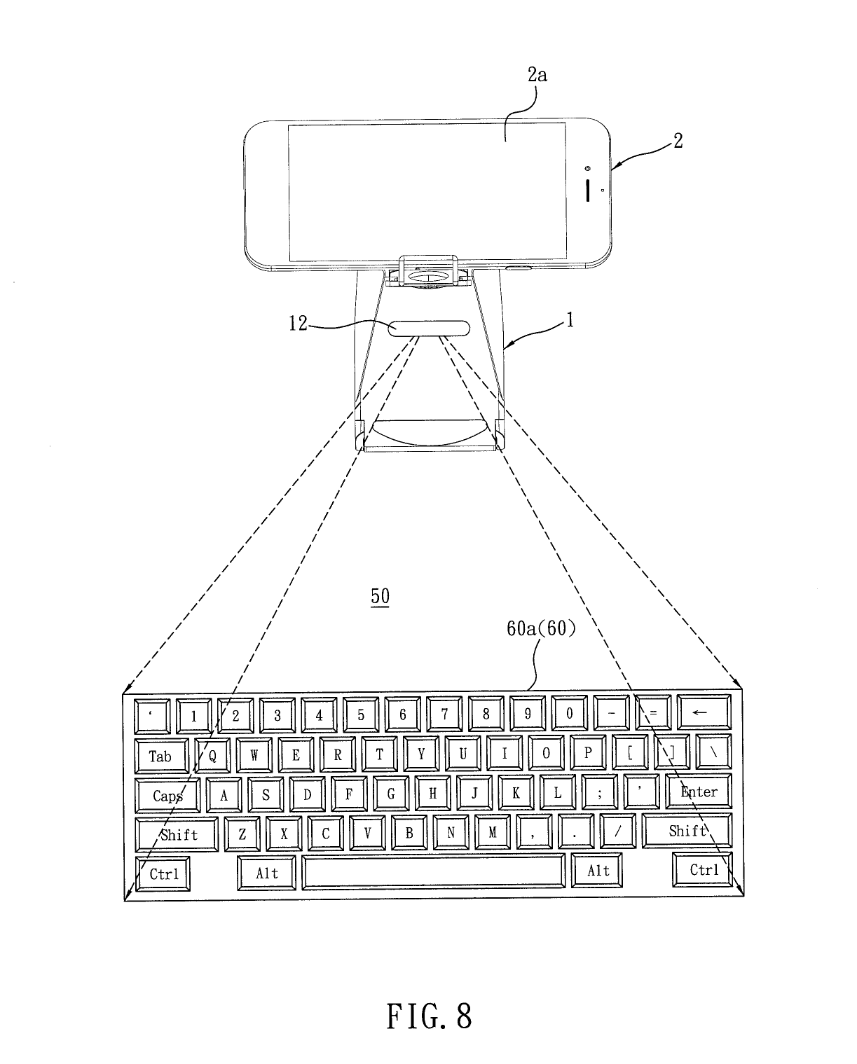

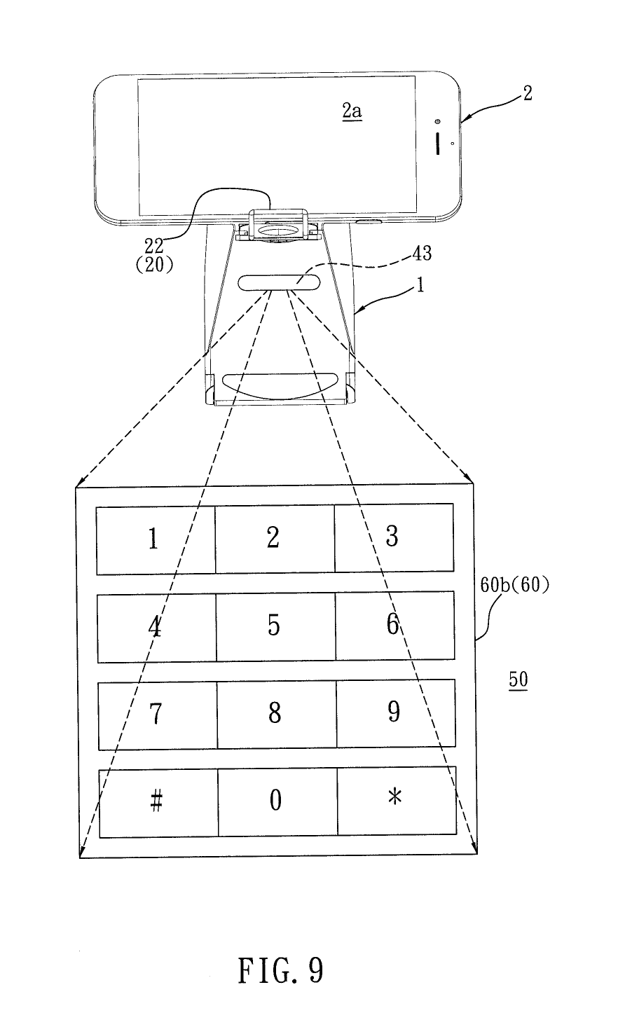

Refer from FIG. 6 to FIG. 11, the virtual input module 40 is mounted in the housing 10 and is able to be connected to a functional system architecture (not shown in figure) in the mobile phone 2 in a wireless way. A virtual input image 60 with virtual input function and area larger than the screen 2a of the mobile phone 2 is formed on a flat surface 50 between the front side of the housing 10 and the user 3 by the virtual input module 40, as shown in FIG. 4, FIG. 5, FIG. 7 and FIG. 11. The virtual input image 60 can be a virtual keyboard image 60a (as shown in FIG. 8), a numeric keypad image 60b (as shown in FIG. 9), a virtual controller image applied to mobile games 60c (as shown in FIG. 10), or a virtual touch screen image (not shown in figure). Thereby the user 3 can complete his/her input or operation of the mobile games by using the virtual input image 60. Thereby the virtual input device 1 of the present invention provides the user 3 of the mobile phone 2 a better and more comfortable operation mode while the user 3 operates or views the screen 2a of the mobile phone 2 for a long period of time. The inconvenience and discomfort of the user 3 are improved.

Refer to FIG. 1, FIG. 6 and FIG. 7, the virtual input module 40 is composed of an infrared (IR) laser light 41, at least two linear line sensors 42, a projector 43 and a controller 44 (such as microcontroller unit (MCU)). The IR laser light 41 is mounted in an opening 11 on a lower part of a front surface of the housing 10 for projecting an IR laser 410 horizontally to form a 2-dimensional (X-Y) light area 411 over, parallel and closed to the flat surface 50. The two linear line sensors 42 set with a preset distance therebetween are arranged in the opening 11 of the housing 10 and used for sensing reflected light 412 of the IR laser 410 caused by a control member 3a (such as fingertip) of the user 3 entering into the 2-dimensional light area 411. Thus a linear position signal is generated by each linear line sensor 42. As shown in FIG. 6, the two linear line sensors 42 are parallel to each other and set on the left side and the right side of the IR laser light 41 respectively. The projector 43 is arranged in an opening 12 on an upper part of a front surface of the housing 10 and used for projecting a virtual input image 60 into the 2-dimensional light area 411, such as a virtual keyboard image 60a in FIG. 8, a numeric keypad image 60b in FIG. 9, a virtual controller image applied to mobile games 60c in FIG. 10, or a virtual touch screen image not shown in the figure. The controller 44 can be a microcontroller unit (MCU) or a central processing unit (CPU) used for receiving and processing the linear position signals from the two linear line sensors 42 to get the position of the control member 3a within a 2-dimensional coordinate system of the virtual input image 60 (60a, 60b, etc.). Then the controller 44 is connected to the mobile phone 2 wirelessly to complete input of the mobile phone 2 or control of the mobile games. For example, the input of the mobile phone 2 includes input of line connection data or contacts data input (such as shown in FIG. 8, FIG. 9 and FIG. 10). The game players can touch the virtual input image 60 directly instead of direct touch of the screen 2a of the mobile phone 2 while playing the mobile game such as Temple Run.

The controller 44 performs processing (such as triangulation) by using linear position signal (as shown in FIG. 7) from the linear line sensor 42. Thus the processing the controller 44 of the present invention performs is simplified compared with the processing of signals obtained by cameras in prior arts such as US2012/0162077, US2014/0055364, etc. Moreover, the virtual input module 40 including the IR laser light 41, the at least two linear line sensors 42, the projector 43 and the controller 44 is mounted in the hosing conveniently owing to the module design, but not limited. The position and size of each unit such as 41, 42, 43, 44 shown in FIG. 6 and FIG. 7 are only certain embodiment, not limited(not intend to limit the present invention).

In summary, the virtual input device for the mobile phone according to the present invention features on simple structure, cost effectiveness, and durability. Moreover, the compact design allows users can carry the virtual input device with them. The virtual input device can be placed on a flat surface stably owing to the housing with a certain volume.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

I claim:

1. A virtual input device for a mobile phone comprising:
a housing having a certain height and volume for stable placement on a flat surface and easy carrying,
a mobile-phone mounting member, and
a virtual input module;
wherein the mobile-phone mounting member is disposed on the housing and allowing the mobile phone of a user to be mounted thereon horizontally or vertically and a screen of the mobile phone to be inclined at an angle; thus the user operates the screen of the mobile phone by touch or views the screen of the mobile phone with better viewing angle and greater comfort;
wherein the virtual input module is mounted in the housing and wirelessly and is connected to the mobile phone for forming a virtual input image on the flat surface between a front side of the housing and the user; the virtual input image having virtual input function and area larger than the screen of the mobile phone; thus the user completes input to the mobile phone or controls mobile game by the virtual input image;
thereby the user is able to operate the mobile phone more efficient and comfort after a long-term use.

2. The claim as claimed in claim 1, wherein the mobile phone is mounted on the mobile-phone mounting member horizontally or vertically while the screen of the mobile phone is inclined at an angle.

3. The claim as claimed in claim 1, wherein the mobile-phone mounting member includes a pivotable flip-up cover covered a top surface of the housing and a pivotable support disposed and mounted under the pivotable flip-up cover; the pivotable flip-up cover is lifted up pivotally and stopped vertically to support a rear surface of the mobile phone while in use; the pivotable support is pivotally moved and stopped vertically to support a front edge of the mobile phone after the pivotable flip-up cover being lifted up; thereby the mobile phone is able to be mounted on the mobile-phone mounting member and inclined at an angle.

4. The claim as claimed in claim 1, wherein the virtual input device further includes a pivotable horseshoe-shaped bracket arranged at an outer surface of a lower part of the housing and close to the bottom surface of the housing; the pivotable horseshoe-shaped bracket is pulled backward and pivotally rotated to be stopped horizontally at a rear side of the housing for supporting the housing while in use.

5. The claim as claimed in claim 1, wherein the virtual input image is selected from a group consisting of a virtual keyboard image, a virtual controller image applied to mobile games, and a virtual touch screen image.

6. The claim as claimed in claim 1, wherein the virtual input module includes an infrared (IR) laser light, at least two linear line sensors, a projector and a controller;
wherein the IR laser light is mounted in an opening on a lower part of a front surface of the housing and used for projecting an IR laser horizontally to form a 2-dimensional light area over, parallel and closed to the flat surface;
wherein the two linear line sensors set with a preset distance therebetween are arranged in the opening of the housing and used for sensing reflected light of the IR laser caused by a control member of the user entering into the 2-dimensional light area and generating a linear position signal respectively;
wherein the projector is set in an opening on an upper part of a front surface of the housing and used for projecting a virtual input image into the 2-dimensional light area;
wherein the controller is used for receiving and processing the linear position signals from the two linear line sensors to get a position of the control member within a 2-dimensional coordinate system of the virtual input image; the controller is connected to the mobile phone wirelessly for input into the mobile phone or operation of the mobile games.

7. The claim as claimed in claim 6, wherein the two linear line sensors are parallel to each other and set on the left side and the right side of the IR laser light respectively.

8. The claim as claimed in claim 6, wherein the control member is users' finger.
